(19) United States
(12) Patent Application Publication
(10) Pub. No.: US 2010/0179065 A1
(43) Pub. Date: Jul. 15, 2010

(54) Clinical monitor systems for botanics and herbal medicine

(76) Inventors: Jen-Hwey Chiu, Taipei City (TW); Jir-You Wang, Taipei City (TW)

Correspondence Address: Muncy, Geissler, Olds & Lowe, PLLC, 4000 Legato Road, Suite 310, FAIRFAX, VA, 22033, US

(21) Appl. No.: 12/319,941

(22) Filed: Jan. 14, 2009

(51) Int. Cl. C40B 20/00; C40B 60/10

(52) U.S. Cl. 506/2; 506/38

(57) ABSTRACT

The present invention provides a biological finger-print system for botanics and/or herbal medicine by using the overall gene expression profiling in peripheral white blood cells. Besides, the present invention further provides clinical application in humans for monitoring the potential adverse or side effects of botanics and/or herbal medicine.

### FIELD OF THE INVENTION

The present invention provides a biological finger-print system for botanics and/or herbal medicine by using the overall gene expression profiling in peripheral white blood cells. Besides, the present invention further provides clinical application in humans for monitoring the potential adverse or side effects of botanics and/or herbal medicine.

### BACKGROUND OF THE INVENTION

Botanics and/or herbal medicine have been used in health-caring and disease therapy for thousand years. However, since the effects of botanics and/or herbal medicine involve very complex mechanisms such as drug-drug, cell-cell and herbs-cells interactions, it is difficult to follow the botanics and/or herbal effects via conventional pharmacological approach.

Genome-wide expression profiling by cDNA microarray has been used as a powerful technique for monitoring changes in gene expression. This technology allows analysis of thousands of genes in parallel and obtains a view of global gene expression. Peripheral WBC gene expression patterns have been used for disease diagnosis (such as Leukemia etc., see Pui, C. H. et al., Hematology 2004, 118-145), prognosis prediction and detection of chemical compound or acetaminophen over-exposure (Jison, M. L., et al., Blood, 2004, 104:270-280; Bushel, P. R., PNAS, 2007, 104:18211-18216), there is no information, to our knowledge, concerning the application of such gene expression profiling in treatment of human disorder by botanics or medicinal herbs.

Owing to the advance of biotechnology, overall gene expression profiling has been wildly used in disease diagnosis, prognosis prediction and detection of drug or chemical compound over-exposure (Forrest, M. S. et al. Environ. Heal. Persp. 2005, 113:801-807). Nevertheless, there is no clinical application of overall gene expression profiling in peripheral white blood cells (WBC) for evaluation and monitoring the biological responses to botanic or herbal medicine in humans.

Therefore, the present invention provides a biological finger-print system for botanics and/or herbal medicine by using the overall gene expression profiling in peripheral white blood cells. Besides, the present invention further provides clinical application in humans for monitoring the potential adverse or side effects of botanics and/or herbal medicine.

### SUMMARY OF THE INVENTION

It is an object of the present invention to use the overall gene expression profiling in peripheral white blood cells in monitoring the potential adverse or side effects of botanics and/or herbal medicine.

In one embodiment, the overall gene expression is detected by oligonucleotides microarray analysis (Affymetrix) of the extracted total RNA.

It is an object of the present invention to provide a method for monitoring the clinical effect of an herbal medicine. In the monitoring method, total RNA of peripheral white blood cell is extracted from the blood sample obtained from a patient receiving the herbal medicine therapy, and used for oligonucleotides microarray analysis (Affymetrix) to determine the biological finger-print of the herbal medicine. The biological finger-print of the herbal medicine is correlated with the qualitative and quantitative analysis to evaluate clinical effects of the herbal medicine.

In a further aspect of the invention, it will provide a clinical monitor system for herbal medicine, which comprises a HPLC analytic device for qualitative and quantitative detection of the drugs; and an oligonuclearotides microarray for analysis of overall gene expression profiling in peripheral white blood cells.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is the flow chart for clinical monitor system design of the invention.

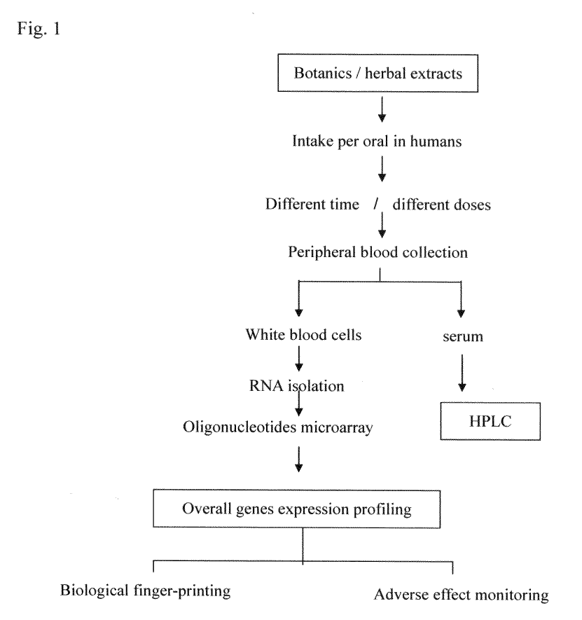

FIG. 2 shows the biological finger-printing effects of an herbal medicine in 4 different subjects. After subjects were told to have Xiao-Tsai-Hu Tang (3 gm) intake once, peripheral blood samples of these subjects were collected before (B) and 4 h- (+) after herbs intake for WBC overall gene expression profiling, respectively.

FIG. 3 shows the overall gene expression profiling in WBC at different time points after intake of a medicinal herb in the same subject.

FIG. 4 shows the overall gene expression profiling in peripheral white blood cells in three independent experiments in which a subject ingests a single dose (3 gm) of herbal medicine at two weeks intervals. The lanes indicate three baseline levels before (1, 2, 3) and after (4, 5, 6) herbal intake at day 0, day 15 and day 29 in protocol 3, respectively

### DETAILED DESCRIPTION OF THE INVENTION

The aim of the present invention is to monitor the biological finger-print effects of Chinese medicinal herb (for example, Xiao-Tsai-Hu Tang) on overall gene expression profile in human peripheral white blood cells. In one embodiment, 3 to 6 healthy volunteers aged 25-55, excluding those who were pregnant, having renal, heart or pulmonary diseases or having herbal medicine intake, were tested in the clinical monitor system. After inform consent, Xiao-Tsai-Hu Tang is prescribed once to volunteers at either low (3 gm) or high (6 gm) dose. At time intervals of 0 h-, 4 h-, and 7 day after herb intake, the peripheral blood samples are collected, followed by isolation of WBC, extraction RNA and finally oligonucleotides microarray analysis.

### DEFINITIONS

For better understanding the present invention, the following terms and phrases shall have the meanings set forth below. Unless defined otherwise, all technical and scientific terms used herein have the same meaning as commonly understood to one of ordinary skill in the art.

As used herein, “biological finger-print effects” of certain herbal medicine refers to the specific biological responses of a subject to whom has been administered the herbal medicine.

As used herein, “overall gene expression profiling” in peripheral white blood cells (RBCs) refers to the overall gene expression pattern of peripheral white blood cells isolated from the subject who has been accepted a test herbal medicine as determined in the oligonucleotide microarray analysis described below.

The term “botanics” and/or “herbal medicine” as used herein include the extract products of one or more natural herbal plants with therapeutical effects, or combinations thereof.

A “patient”, “subject”, or “individual” refers to a human to be treated by an herbal medicine.

As used herein, “cDNA microarray” refers to an arrayed series of thousands of microscopic spots of cDNA oligonucleotides, called features, each containing picomoles of a specific cDNA sequence. In standard microarrays, the probes are attached to a solid surface by a covalent bond to a chemical matrix (via epoxy-silane, amino-silane, lysine, polyacrylamide or others). The solid surface can be glass or a silicon chip, in which case they are commonly known as gene chip or colloquially Am chip when an Affymetrix chip is used.

### Metrology

Isolation of RNA from peripheral white blood cells. The RNA from human peripheral WBC was isolated with Qiagen RNeasy mini kit as manufacturer's instruction (Qiagen, 79254, Tezas, USA). The concentration of total RNA required for oligonucleotide microarray analysis should be at least 0.6 μg/μl and the quality 260/280 and 260/230≧1.8.

Oligonucleotide microarray analysis. The RNA samples were sent to National Research Progress for Genomic Medicine, Microarray & Gene expression Analysis Core Facility, National Yang-Ming University VYM genome research center for human affymetrix expression set human U133 2.0 microarray analysis (Affymetrix, Seattle, USA).

Data analysis: The outcomes were analyzed after normalizing to the global signal and the relative expression level of each gene was analyzed by Genespring software.

### EXAMPLES

The present invention will be more readily understood by reference to the following examples, which are included merely for purposes of illustration of certain aspects and embodiments of the present invention, and are not intended to limit the invention in any way.

### Example 1

### Biological Finger-Printing Effects of an Herbal Medicine in Different Subjects

3-6 healthy volunteers, 25-55 y/o, either male or female were included in this study. Those who have liver disease (Bil.>2.0 mg/dl), renal disease (Cr.>1.0 mg/dl), heart disease (arrhythmia), pulmonary disease (x-ray findings), pregnancy, or have previous history of herbs intake were excluded.

An over-the-counter herbal medicine (Xiao-Tsai-Hu Tang, Bupleuri-B Tong) was commercially obtained from a GMP manufacture (Product number: 028852, Sheng Chang Co, Taiwan). Xiao-Tsai-Hu Tang is a mixed remedy (6 gm) extracted from Bupleurum scorzonerifolffium (8.0 gm), Scutellaria baicalensis (3.0 gm), Pinellia ternate (5.0 gm), Zingiber officinale (3.0 gm), Zizyphus jujuba (2.0 gm), Panax ginseng (3.0 gm), Glycyrrhiza uralensis (3.0 gm). The quality and quantification of contents in this product were standardized with HPLC profiling by Sheng Chang GMP Company.

Subjects were told to have Xiao-Tsai-Hu Tang (3 gm) intake once. Peripheral blood samples of these subjects were collected before and 4 h- after herbs intake, respectively. Overall gene expression profiling in peripheral WBC could be used as an indicator for biological finger-print responses to an herbal medicine in different subjects.

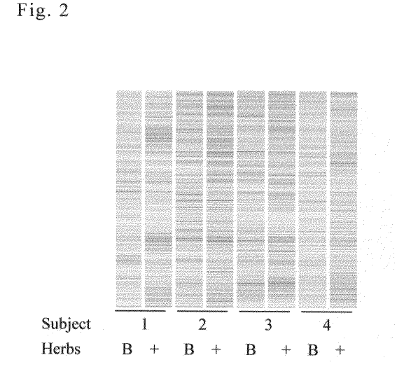

It is of note that the individual WBC responses to an herbal medicine are different, in terms of overall expression patterns, in different subjects. For example, there are many genes clusters, such as proinflammatory genes (IL-1β, TNF-α, IL-6 etc.) and anti-inflammatory genes (IL-10 etc.) could be identified (there are many genes clusters remain to be determined), might reflex the WBC responses and subsequently cause potential adverse effects after ingestion of a medicinal herb. These genes clusters patterns in each subject are not similar to each other after their ingestion of a medicinal herb. As showed in FIG. 2, after subjects were told to have Xiao-Tsai-Hu Tang (3 gm) intake once, there were different WBC overall gene expression patterns in different subjects, indicating the finger-print effects for a subject responses to the indicated medicinal herb, which provide important information in predicting the occurrence of potential adverse or side effects after medicinal herbal intake.

### Example 2

### Phamacokinetics of an Herbal Medicine in the Same Subject

Subjects were told to have Xiao-Tsai-Hu Tang (3 gm) intake once. Peripheral blood samples of the same person were collected before, 4 h-, 24 h- and 7-day after herbs intake, respectively. Overall gene expression profiling in peripheral WBC could be used as an indicator for pharmacokinetic change of WBC responses to an herbal medicine.

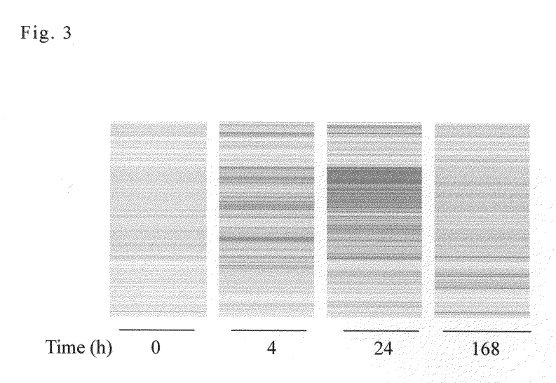

The results showed there were obvious pharmacokinetic changes of WBC overall gene expression patterns in the same subject (FIG. 3). The changes of gene expression patterns in several genes clustered suggest a kinetic WBC response to one shot of medicinal herbal intake. Such kinetic changes provide important information in predicting the WBC responses to herbal metabolites and, hence, provide the application of such invention in clinical pharmacology.

### Example 3

### Wash-Out Effect of an Herbal Medicine in the Same Subject

Subjects were told to have Xiao-Tsai-Hu Tang (3 gm) intake for three doses at two weeks interval, namely, 1^{st} dose at day 0, 2^{nd} dose at day 15 and 3^{rd} dose at day 29. Peripheral blood samples were collected just before and 4 h after herbs intake, respectively. Overall gene expression profiling in peripheral WBC could be used as an indicator for wash-out effect of an herbal medicine treatment.

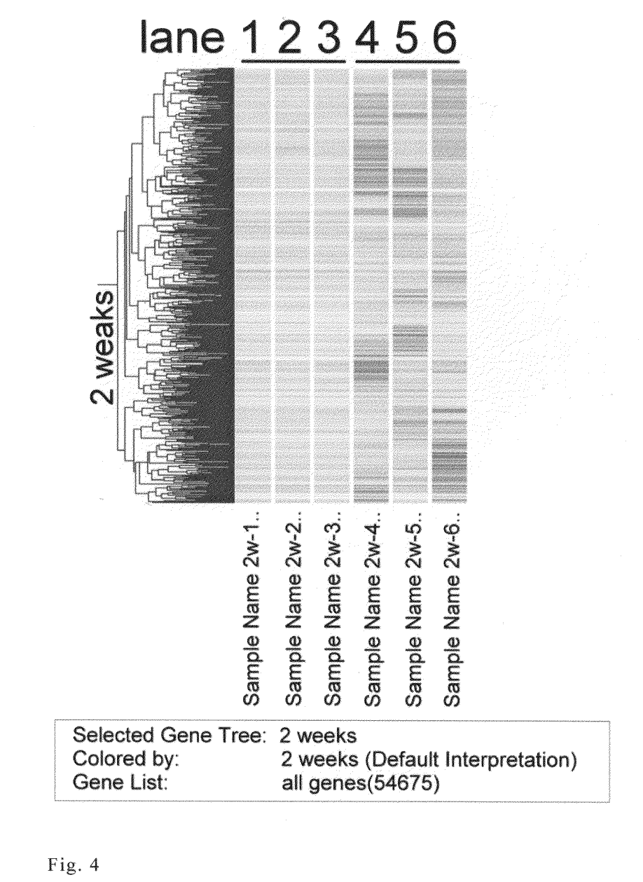

As shown in FIG. 4, lane 1, 2, and 3 indicate three baseline levels (before herbal intake at day 0, day 15 and day 29 in protocol 3, respectively) of WBC gene expression profiling in three independent experiments. It is of note that overall gene expression profiling in base levels (FIG. 3, lane 1, 2 and 3) show similar patterns, indicating the wash-out time period is adequate for such herbal medicine prescription.

### Example 4

### Monitoring System for an Herbal Medicine in the Same Subject

Subjects were told to have Xiao-Tsai-Hu Tang (3 gm or 6 gm) intake once. Peripheral blood samples of the same person were collected before and 4 h after herbs intake, respectively. A crossing-over study design (3 gm to 6 gm followed by 6 gm to 3 gm after one month wash-out period was conducted. Overall gene expression profiling in peripheral WBC could be used as an indicator for monitoring the biological responses to an herbal medicine with different dosage.

Three therapeutic patterns (4 h after herbal intake) of WBC gene expression profiling in three independent experiments in which a subject ingests a single dose (3 gm) of herbal medicine at two weeks interval, respectively. The results in FIG. 4 show that the WBC overall gene expression patterns in three independent experiments (FIG. 4, lane 4, 5, and 6) are different from each other suggests such WBC profiling can be used as a unique system to monitor the biological finger-print effects or adverse effects of botanics and/or herbal medicine.

The monitor system of the invention can be applied in humans to detect the effects and to monitor the body responses to a remedy containing mixed compounds or botanics, a method quite different from the methods previously described in disease diagnosis or detection of over-exposure of a pure compound.

1. A method for monitoring the clinical effect of a herbal medicine, which comprises the steps of:
(1) Blood sample collection and separation of serum and peripheral white blood cells from the sample from patients receiving the herbal medicine therapy;
(2) qualitative and quantitative analysis of the herbal medicine in the patient's serum;
(3) extraction of total RNA from the peripheral white blood cells;
(4) oligonucleotides microarray analysis (Affymetrix) of the extracted total RNA for detecting the overall gene expression profiling in peripheral white blood cells to determine the biological finger-print of the herbal medicine; and
(5) correlating the results of the qualitative and quantitative analysis and biological finger-print of the herbal medicine to evaluate clinical effects of the herbal medicine.

2. The method of claim 1, wherein the microarray is Affymetrix oligonucleotides microarray.

3. A clinical monitor system for herbal medicine, which comprises a HPLC analytic device for qualitative and quantitative detection of the drugs; and an oligonuclearotides microarray for analysis of overall gene expression profiling in peripheral white blood cells.

4. The clinical monitor system of claim 3, wherein the microarray is Affymetrix oligonucleotides microarray.
